(19) United States
(12) Patent Application Publication
(10) Pub. No.: US 2008/0295174 A1
(43) Pub. Date: Nov. 27, 2008

(54) Method and System for Preventing Unauthorized Access and Distribution of Digital Data

(76) Inventors: Andrea Robinson Fahmy, Duluth, GA (US); Rolf Hunt, Marietta, GA (US); Ryan Taylor, Duluth, GA (US)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 12/042,976

(22) Filed: Mar. 5, 2008

Related U.S. Application Data
(60) Provisional application No. 60/904,957, filed on Mar. 5, 2007.

(51) Int. Cl. G06F 21/22; H04L 9/00

(52) U.S. Cl. 726/23; 726/27; 380/59

(57) ABSTRACT

A system and method for preventing tampering and unauthorized access to digital data stored on a device. The system can include 1) a data store for containing digital data to be protected and a listing of processes permitted to access the digital data, 2) a filter driver for intercepting a request issued from a process to access the digital data, 3) a central processor, in communication with the data store, upon receipt of a notification of the intercepted request from the filter driver, deciding to grant or deny the request by determining whether the process issuing the request is on the listing of processes permitted to access the digital data, and 4) a monitor process for monitoring one or more software components of the system including the central processor, filter driver, and data store, and for identifying and preventing any unauthorized processes from accessing and tampering with the software components of the system.

### CROSS REFERENCE TO RELATED APPLICATIONS

This claims the benefit of U.S. Provisional Patent Application Ser. No. 60/904,957, filed on Mar. 5, 2007, which is incorporated herein by reference in its entirety.

### FIELD OF THE INVENTION

The present invention generally relates to digital data protection, and more particularly to preventing unauthorized access and distribution of digital data.

### BACKGROUND OF THE INVENTION

In today's digital age, many technology users take for granted the ability to access and distribute digital data and files across remotely located computer and communication networks, or to play compact disks in their CD-ROM drives, store and transport music with MP3 compression, and create copies or customize mixes from their compact disks (CDs). Although the underlying technologies have many legal and useful applications, they are frequently used to produce illegal copies of digital data, which can then be distributed to almost any other party over the Internet. Digital data including music, videos, books, text, graphics, data files, and software applications are often downloaded from the Internet freely with complete disregard for copyright laws.

Various techniques and technologies have been introduced to secure platforms and devices, and to prevent unauthorized access of the digital data housed on the platforms and devices. Typically, such technologies protect only certain types of digital data, or are configured to secure only certain types of platforms and devices. Such technologies have had little impact on the millions of PCs, and consumer electronics devices that are capable of copying music, video, text, data files, etc. As a result, the unauthorized access and distribution of digital data remains commonplace.

Accordingly, there is a need for an innovation that can effectively prevent the unauthorized access and distribution of any type of digital data, and can be implemented on a wide variety of platforms and devices.

### SUMMARY OF THE INVENTION

In an aspect, the invention features a system and method for preventing tampering and unauthorized access to digital data stored on a device. The system can include a data store for containing the digital data to be protected, and a listing of processes that are permitted to access the digital data. A filter driver can be included for intercepting a request issued from a process to access the digital data. A central processor can be in communication with the data store, and upon receipt of a notification of the intercepted request from the filter driver, the central processor can decide to grant or deny the request by determining whether the process issuing the request is on the listing of processes permitted to access the digital data. The system can also include a monitor process for monitoring one or more software components of the system including the central processor, filter driver, and data store, and for identifying and preventing any unauthorized processes from accessing and tampering with the software components of the system. Status fields associated with the central processor, filter driver, data store, and other software components of the system can be monitored to identify unauthorized changes in the status field. Responses to changes in the status fields can include 1) sending notification of tampering to a remote server, 2) generating an irrecoverable error condition requiring reboot of the system, 3) disabling the system permanently to prevent unauthorized access to the digital data, and 4) a combination of 1) through 3).

In another aspect, the invention features a method of preventing unauthorized access to digital data stored on a device. The method includes providing a data store of protected digital data, receiving a request for digital data from a process, and determining whether the request is for protected or not protected digital data. If the request is for protected data, the method can grant the request if the process is authorized to access the digital data, or the method can deny the request if the process is not authorized to access the digital data.

Embodiments may include one or more of the following features. The filter driver may be designed to permit the requesting process to access the digital data or to deny access to the digital data, based on instructions received from the central processor. A status field can be associated with each software component of the system, and can be modifiable by each respective software component to indicate whether unauthorized access or tampering to the software component has occurred.

Each monitor process can be capable of monitoring each software component of the system to determine the status of each of the software components. The monitor process can include an installer software component for reinstalling damaged or compromised components of the system. Each monitor process can be identical to every other monitor process, and each monitor process can operate autonomously in a shared memory area for interprocess communication. Each monitor process may be capable of spawning additional iterations of itself that operate simultaneously on the system.

Each monitor process can track every other monitor process to ensure each monitor process is not tampered with by an unauthorized process. Additional iterations of the monitor process can be generated when tampering is identified, and each additional iteration can operate simultaneously with other copies of the monitor process. Alternatively, the operation of each tampered with monitor process can be terminated.

The monitor process can be capable of rebooting the system, and wiping the operating system to prevent tampering or unauthorized access to the digital data. The monitor process can ensure installation of the filter driver, continued operation of the central processor, and integrity of the data store.

Each software component of the system can be monitored to identify changes in the status of the component. The status of each software component can be encrypted with a proprietary scheme to ensure the status is not modified by a rogue process. Operating system processes and device driver configuration parameters can be monitored to identify unauthorized activity. A reinstall routine can be launched to upgrade damaged or compromised components of the system. A remote server can be connected to via a network connection to regenerate or download upgrades of compromised components of the system. A software virus can be passed along with any unauthorized download of protected digital data.

In embodiments, the system can be designed for use in a number of devices including an iPod, Blackberry, cellphone, PDA, computer, network device, or consumer electronics device. In addition, the system can be designed for use in a proprietary hardware device running a Linux-based operating system.

In an embodiment, the present invention can provide a system and method for preventing the unauthorized access, duplication, download, and distribution of protected files and content on a computer, data store, or network device. The system can include 1) a central processor that controls the overall functionality of the system, 2) a file system filter driver that can communicate with the central processor, and can act as a gate keeper to the protected file data, 3) a data store, such as a catalog or other data repository of permitted process information, and a list of which files can be protected by the system, and 4) a self-spawning monitor process that can ensure the installation of the filter driver, the continued running of the central processor, and the integrity of the data store.

In an embodiment, the present invention can be configured to protect every file flagged as having copy protected content on a computer. Alternatively, the system can be configured to protect only certain files.

In an embodiment, the present invention can provide a data store, such as, a catalog that contains both, information about which files may be protected, and a listing of authorized processes that can add and remove files from the data store. The data store can be secured from tampering by encrypting the data in the data store, and by process level measures.

In another embodiment, the present invention can provide a file system filter driver that can control access to protected file data. Filter drivers wrap the actual hardware driver, or as in one embodiment, file system driver, and have the ability to limit data moving in and out of any lower level driver. When a process requests access to a protected file, the filter driver can notify the central processor of the event. The central processor can then allow or deny the requested access to the protected file, based on whether or not the requesting process is listed in the catalog as an authorized process. Alternatively, the central processor can be configured to grant access to any requesting process, which is not involved in network I/O or other disk I/O.

In an embodiment, the present invention can provide a system that can be configured as part of a consumer electronics device, rather than an end-user software component for a traditional PC environment. In such an embodiment, the data store can be configured as a full file system, and the filter driver can be replaced with the file system driver.

In another embodiment, the present invention can operate by identifying copyrighted digital files by a marker or flag in the header of a file, and allowing or preventing user actions based on the presence or absence of that copyright marker. User actions include transmission of a digital file over the Internet; transmission of digital files to a destination computer on a local network; burning of copyrighted digital files by an unauthorized burn program; and burning of copyrighted tracks. The media copy control (MCC) program responds to user actions on a digital file type that is identified as being potentially copyrighted. The media copy control program also deals with format conversion (e.g., compressed files) and Internet or network file transfers. The media copy monitor (MCM) program regulates a CD, DVD, Blu-ray disk, or game cartridge burn process and ensures that media copy control and media copy monitor programs are included on any CD, DVD, Blu-ray disc, or game cartridge that is burned.

### BRIEF DESCRIPTION OF THE DRAWINGS

The invention is better understood by reading the following detailed description of the invention in conjunction with the accompanying drawings.

FIG. 1 illustrates the processing logic for the media copy control installation module in accordance with an exemplary embodiment of the present invention.

FIG. 2 illustrates the processing logic for the media copy control program for accessing digital files over a network connection in accordance with an exemplary embodiment of the present invention.

FIG. 3 illustrates the processing logic for the media copy control burn module in accordance with an exemplary embodiment of the present invention.

FIG. 4 illustrates the processing logic for the media copy monitor program, in accordance with an exemplary embodiment of the invention.

FIGS. 5A and 5B illustrate the processing logic for the media copy control editing and insertion modules in accordance with an exemplary embodiment of the invention.

FIG. 6 illustrates the processing logic for the media copy control compression/encryption module in accordance with an exemplary embodiment of the invention.

FIG. 7 illustrates the processing logic for the media copy control format conversion module in accordance with an exemplary embodiment of the invention.

FIG. 8 illustrates the processing logic for the media copy control analog audio module in accordance with an exemplary embodiment of the invention.

FIG. 9 illustrates a system architecture and components of an embodiment of the present invention.

FIG. 10 illustrates the processing of file access requests in accordance with an embodiment of the present invention.

FIG. 11 illustrates the operation of a system designed in accordance with an embodiment of the present invention.

### DETAILED DESCRIPTION OF SPECIFIC EMBODIMENTS

The following description of the present invention is provided as an enabling teaching of the invention in its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without using other features. Accordingly, those who work in the art will recognize that many modifications and adaptations to the present invention are possible and may even be desirable in certain circumstances, and are a part of the present invention. Thus, the following description is provided as illustrative of the principles of the present invention and not in limitation thereof since the scope of the present invention is defined by the claims.

In the present invention, digital data refers broadly to any form of information stored in digital form. This includes, but is not limited to, music, books, and video files stored on CDs, DVDs, Blu-rays, game cartridges or computer storage devices including digital files available for downloading from the Internet, either via file swapping software or server devices. The principles of the present invention apply to all forms of digital data.

### Application to CD Technology

In an embodiment, the present invention provides a media copy control program and a media copy monitor program. The basic principle of the media copy control and media copy monitor programs is as follows: identifying copyrighted files by a marker or flag in the header of a file, and allowing or preventing functions based on the presence of that copyright. Controlled functions include transmission over the Internet; transmission of files to a local network computer that does not have media copy control or media copy monitor installed; burning of copyrighted files by a program other than approved programs; or burning of copyrighted tracks without the inclusion of the media copy control or media copy monitor programs in the disk. Media copy control (MCC) is the system program that deals with user actions on a file type that are identified as being potentially copyrighted. The media copy control module also deals with format conversion (e.g., compressed files) and Internet or network file transfers. Media copy monitor (MCM) is the system program that can intercede in a CD burn process and can ensure that media copy control and media copy monitor are both included on any CD that is burned. This process is further explained below in terms of what actions a user is attempting to perform with a copyrighted CD or file.

The media copy control program can detect a number of user actions, including the following: (1) inserting a copyrighted disk into a computer; (2) moving a copyrighted file from CD to a hard drive; (3) changing the format of a file; (4) transmission of a file over the Internet; (5) transmission of a file over a local network; (6) burning of an entire CD (CD image); and (7) burning a mix CD (any or all copyrighted files).

When the user inserts a CD into the CD-ROM or DVD drive of a computer, the media copy control program is accessed first on the disk (as per operating system standards) and will look for itself on the hard drive of the computer. The media copy control program will self-install if no current version of the media copy control program is found. If the media copy control program is found on the hard drive, the program will not auto-install, and the user can access the disk. The media copy control program will install the media copy monitor program. The user is then able to access the disk.

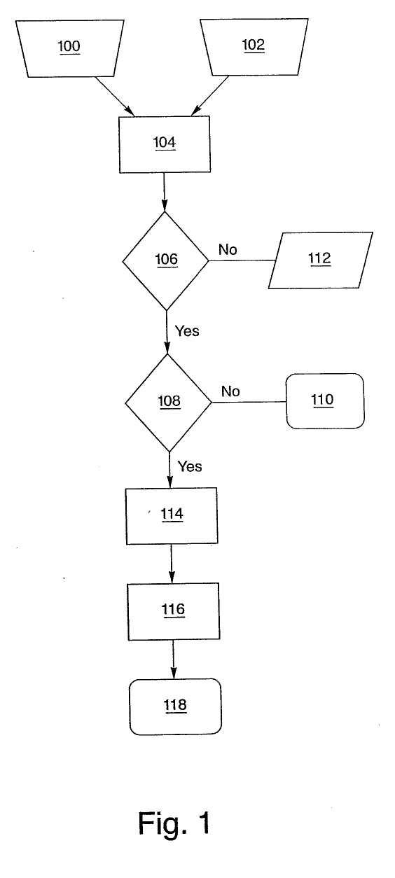

FIG. 1 illustrates the processing logic for the media copy control installation module in an exemplary embodiment of the invention. The process starts with either Internet music service 100 being accessed or a CD 102 being inserted into a computer. The media access control program is introduced to the computer from the Internet or directly from the production CD inserted into the computer CD-ROM drive. The media copy control installation module then runs as indicated in logic block 104. A test is then made in decision block 106 to determine if the copy control program is installed and running. If the copy control program is not installed, then the copy control and copy monitor programs are installed as indicated in logic block 112. In decision block 106, if the copy control program is installed and running, a test is then made in decision block 108 to determine if the installed version is an older version than that introduced via the Internet music service 100 or the CD 102. If the installed version is not older, processing exits the installation module as indicated in logic block 110. If the installed version of the copy control program is older, as determined in logic block 108, then the copy control and copy monitor programs introduced via the Internet music service 100 or CD 102 is installed. The copy control program can then run on the computer as indicated in logic block 114. A popup window can be displayed optionally to the user including possible copyright disclaimers as indicated in display block 116. The copy control program then returns to a “watchdog” or passive mode as indicated in block 118.

When a user tries to move a copyrighted file from a CD to the hard drive of the computer, the media copy control program checks the file for the presence of a copyright flag. If a copyright flag is present, the file header is grabbed and temporarily held. If no copyright flag is found, the media copy control program returns to passive mode. The media copy control program launches the file as it is copied onto the hard drive. When the file is written, the media copy control program re-checks the copyright marker and ensures that it has not been tampered with. If the marker has been changed or removed, the media copy control program rewrites the marker. Media copy control then returns to a passive mode.

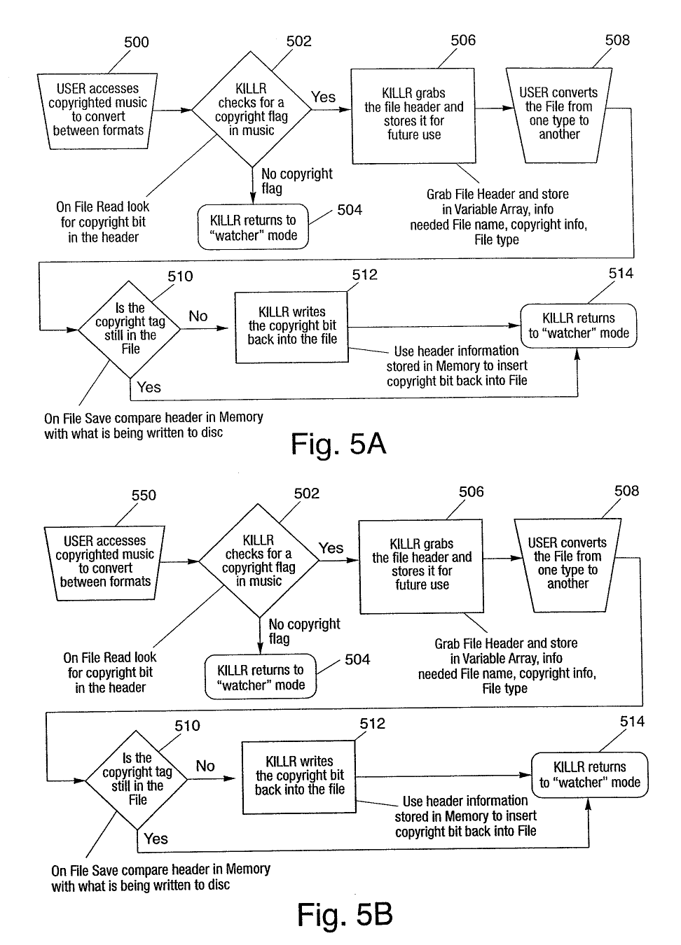

FIGS. 5A and 5B illustrate the processing logic for the media copy control editing and insertion modules, respectively, in an exemplary embodiment. Except for the user's action in logic block 500 (FIG. 5A) or logic block 550 (FIG. 5B) the processing steps are the same. If the user accesses copyrighted music for use in an editing program as indicated in logic block 500, then the copy control program checks for a copyright flag in the music as indicated in decision block 502. If no copyright flag is found, the copy control program returns to a watchdog mode as indicated in logic block 504. If a copyright flag is found in the copyrighted music in decision block 502, the copy control program grabs the file header and stores it for future use as indicated in logic block 506. The user then edits and saves the file as indicated in logic block 508. Next, as indicated in logic block 510, a determination is made as to whether or not the copyright flag is still in the file. If it is not in the file, the copy control program writes the copyright bit back into the file as indicated in logic block 512. If the copyright flag is determined to still be in the saved file in decision block 510, then the copy control program returns to the watchdog mode as indicated in logic block 514. Likewise, after the copy control program writes the copyright bit back into the saved file in logic block 512, the copy control program returns to the watchdog mode in logic block 514. As indicated, the processing for the user action of accessing copyrighted music to insert in an editing program, as illustrated in FIG. 5B is the same as the processing logic illustrated in FIG. 5A.

When a user wants to change the format of a file and accesses a copyrighted file, the media copy control program identifies the type of program that is accessing the file and determines if it is an editing or “ripping” program. The media copy control program grabs the header of the file that is being worked with. Media copy control can approve the file type to which the user wants to convert. Media copy control allows standard formats such as MP3, WMA, CD-A and WAV. Encryption and compression formats (e.g., ZIP, RAR) are not permitted. The media copy control checks the new file for the header. If the header has been modified or erased, the media copy control program replaces it in the correct place and format for the new file type. Once the file is closed, media copy control returns to a passive mode.

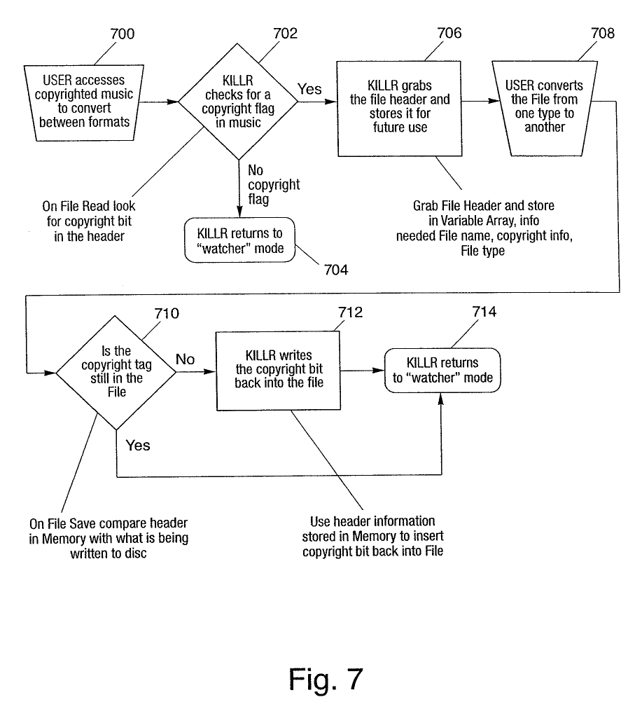

FIG. 7 illustrates the processing logic for the media copy control format conversion module in an exemplary embodiment. Processing starts in logic block 700 with the user accessing copyrighted music to convert between formats. In decision block 702, a test is made to determine if the copy control program has found a copyright flag in the music. If no copyright flag is found, the copy control program returns to a watchdog mode as indicated in logic block 704. If the copy control program finds a copyright flag in the music in decision block 702, then the copy control program grabs the file header and stores it for future use, as indicated in logic block 706. Next, as indicated in logic block 708, the user converts the file from one type to another. In decision block 710, a test is made to determine if the copyright flag is still in the file. If it is, then the copy control program returns to a watchdog mode as indicated in logic block 714. If the copyright flag is not in the converted file, then the copy control program writes the copyright bit back into the file as indicated in logic block 712. From this block, the copy control program returns to a watchdog mode as indicated in logic block 714.

If the user accesses a file type over the Internet, the media copy control program checks the file for a copyright marker. If no marker is found, the media copy control program returns to a passive mode. If there is a copyright flag, the media copy control program identifies the destination of the file. If it is determined that the file is being transmitted over an open Internet connection, the media copy control program will terminate the process and inform the user that access to the file has been denied. The media copy control program will close the file, if necessary, and return to passive mode.

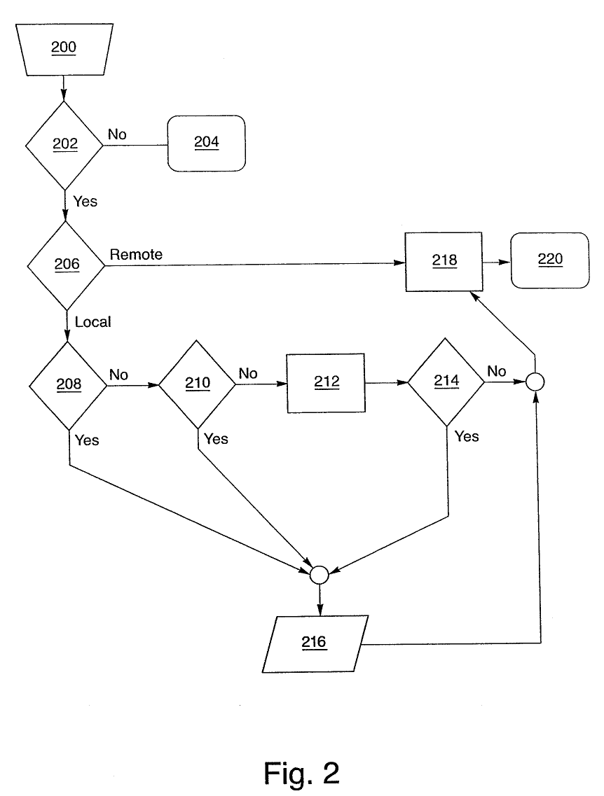

FIG. 2 illustrates the processing logic for the media copy control program for accessing digital files over a network connection in an exemplary embodiment. In logic block 200, the user accesses copyrighted music to send over a network connection. In decision block 202, a test is made by the copy control program to determine if there is a copyright flag in the music. If no copyright flag is found, then in logic block 204, the copy control program returns to a watchdog or passive mode. If a copyright flag is found in the music in decision block 202, a test is made in decision block 206 to determine if the destination is on a local network or a remote network. In this decision block, the processing logic uses an “ANDing” process to determine whether the destination is local or remote. A comparison is also made to a list of hosts in an Address Resolution Protocol (ARP) table preventing transmission to a default gateway. If the destination is remote, then in logic block 218, file transfer is denied to the user. The copy control program then returns to a watchdog mode as indicated in logic block 220.

If the user attempts to access a file over a local network, the media copy control program checks the file for a copyright marker. If no marker is found, the media copy control program returns to passive mode. If there is a copyright flag in the access file, the media copy control program identifies the destination of the file. If the file is being transmitted over a local network, the media copy control program identifies the type of device to which the file is being sent. If it is determined that the receiving device is a “read only” device (e.g., TiVo or Sony Home Theater), the media copy control program will allow the transfer and then return to passive mode. If the receiving device is another computer the media copy control program will determine if it (i.e., media copy control) is installed on the remote computer. If it is installed, the transfer is allowed. If the media copy control program is not installed, the media copy control program will attempt to install itself and the media copy monitor program on the remote computer. Once the installation is complete, media copy control program will allow the file to transfer. If the media copy control program cannot install itself, the transfer will not be permitted.

The processing logic for sending copyrighted music over a local network is also illustrated in FIG. 2. If a determination is made in decision block 206 that the destination is on a local network, then in decision block 208, a determination is made as to whether or not the destination has the copy control program installed. If the destination does have the copy control program installed, then transfer of the music over the local network connection is allowed as indicated in logic block 216. From this point, the copy control program returns to a watchdog mode. If the destination does not have the copy control program installed, as determined in decision block 208, then in decision block 210, a test is made to determine if the destination is a “home media terminal.” If it is, then transfer to the destination of the copyrighted music is then allowed as indicated in logic block 216. If it is determined in decision block 210 that the destination is not a home media terminal, an attempt to control the copy control program on the remote destination machine is made as indicated in logic block 212. A test is made in decision block 214 to determine if the copy control program was installed successfully. If the installation was successful, then transfer of the copyrighted music to the destination is allowed, as indicated in logic block 216. Otherwise, the file transfer of the copyrighted music is denied as indicated in logic block 218. The copy control program then returns to a passive mode as indicated in logic block 220.

If a user attempts to burn a copy of media on to a CD, the media copy control program checks the media to determine if it is copyrighted, and if the media copy control program is on the disk. If the copyright marker is not on the disk, the media copy control program returns to a passive mode. If it is determined that the CD is copyrighted, the media copy control program calls the media copy monitor program to monitor the burn. The media copy control then returns to passive mode. Media copy monitor ensures that the new disk image includes both the media copy control and media copy monitor programs. If they are both included on the disk image, the media copy monitor program allows the burn and returns to a passive mode. If the media copy control and media copy monitor programs are not included on the disk, the media copy monitor program will prevent the burn.

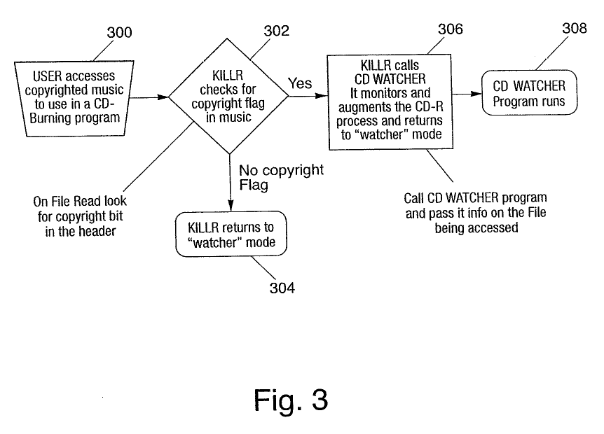

FIG. 3 illustrates processing logic for the media copy control burn module, in an exemplary embodiment. The processing starts in block 300 with the user accessing copyrighted music to use in a CD-burning program. In decision block 302, the copy control program checks for a copyright flag in the music. This step involves looking for a copyright bit in the file header in a read operation. If no copyright flag is found in decision block 302, the copy control program returns to a watchdog mode as indicated in logic block 304. If the copy control program does find a copyright flag in the music in decision block 302, then the copy control program calls the copy monitor program as indicated in logic block 306. The copy monitor program monitors and augments the CD-R process and then returns to a watchdog mode. From logic block 306, the copy control program initiates operation of the copy monitor program as indicated in block 308.

If the user attempts to burn a mix CD in which some or all of the tracks are copyrighted, the media copy control program checks for a copyright marker. If no marker is found, the media copy control program returns to a passive mode. If a copyright marker is found, the media copy control program identifies the type of program that is accessing the file, and determines that it is a burning program. The media copy control program calls the media copy monitor program and returns to passive mode. The media copy monitor program determines if the burn program is approved. The approved list will include the most widely used burning software programs. If it is not, the media copy monitor program prevents the file being moved into the burn program. If the program is approved, the media copy monitor program allows the file to be moved. Media copy monitor then inserts the media copy control and media copy monitor programs onto the disk layout before it is burned. The media copy monitor program does not allow a disk containing a copyrighted file to be burned without the addition of the media copy control and media copy monitor programs.

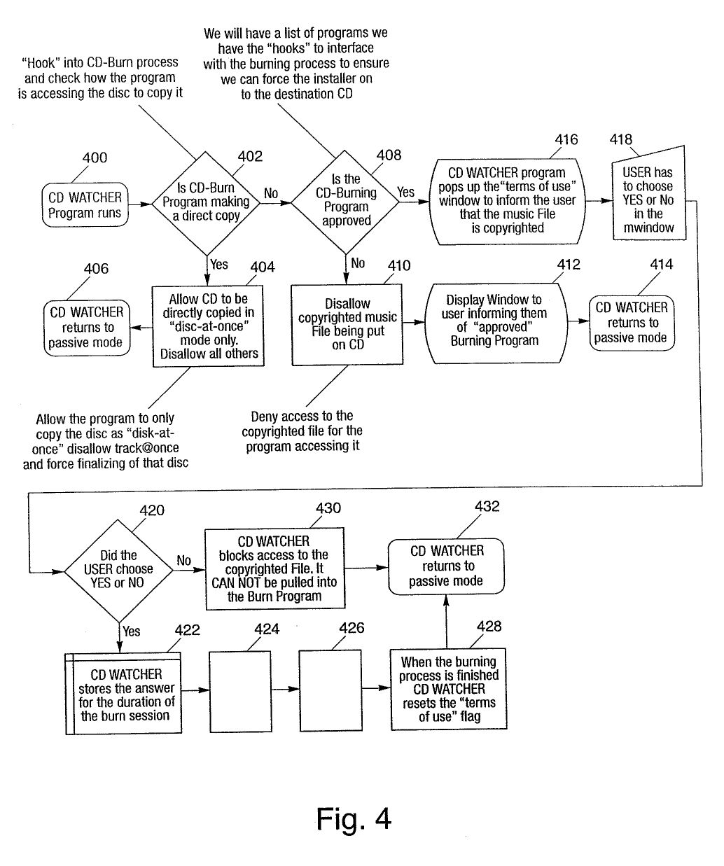

FIG. 4 illustrates the processing logic for the media copy monitor program in an exemplary embodiment. Once the copy monitor program is invoked in logic block 400, a test is made in decision block 402 to determine if the CD-burn program is making a direct copy of copyrighted material. If it is, then in logic block 404, the copy monitor program allows the CD to be directly copied in a “disk-at-once” mode only, as indicated in logic block 404. The copy monitor program then returns to a passive mode as indicated in logic block 406. If a determination is made in decision block 402 that the CD-burn program is not making a direct copy, then in decision block 408, a test is made to determine if the CD-burn program is approved. If the CD-burn program is not an approved program, then the copyrighted music file is prevented from being put onto a CD as indicated in logic block 410. This is followed by a display to the user informing them of “approved” burning programs as indicated in display block 412. The copy monitor program then turns to a passive mode as indicated in logic block 414. If it is determined in decision block 408 that the CD-burn program is approved, then the copy monitor program pops up the “terms of use” window to inform the user that the music file is copyrighted and that the copy control program will be going with the copied music file onto the CD. The user has to make a choice of “yes” or “no” in the displayed window, as indicated in logic block 418. A test is then made in decision block 420 to determine if the user selected “yes” or “no”. If the user chose “no,” the copy monitor program blocks access to the copyrighted file, thus preventing the file from being pulled into the burn program as indicated in logic block 430. The copy monitor program then returns to a passive mode as indicated in logic block 432. If the user chose “yes” in the terms of use window, then the copy monitor program stores the user's response for the duration of the burn session as indicated in logic block 422. The copy monitor program then inserts the “installer” module into the CD on track 00 as indicated in logic block 424. The copy monitor program ensures that the installer program is burned onto the CD in logic block 426. The copy monitor program resets the terms of use flag when the burning process is completed as indicated in logic block 428. The copy monitor program returns to a passive mode as indicated in logic block 432.

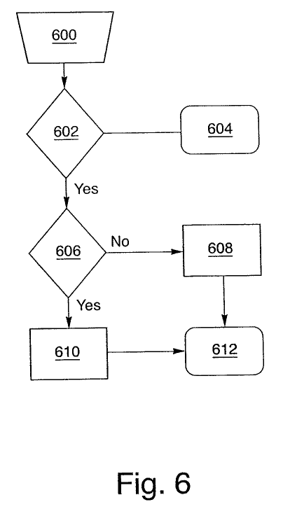

FIG. 6 illustrates the processing logic for the media copy control compression/encryption module in an exemplary embodiment. In logic block 600, the user accesses copyrighted music to compress or encrypt. In decision block 602, the copy control program checks for a copyright flag in the music. If a copyright flag is not found, then the copy control program returns to a passive, watchdog mode as indicated in logic block 604. If the copy control program finds a copyright flag and the music, then a test is made in decision block 606 to determine if the operating system stores the file in an operating system compressed format. If the file is not stored in a compressed format, then access to the file is prevented by the copy control program as indicated by logic block 608. The copy control program then returns to a watchdog mode as indicated in logic block 612. If it is determined in decision block 606 that the operating system stores the file in a compressed format, then the operating system is allowed to physically compress the file as indicated in logic block 610. The copy control program then returns to a watchdog mode as indicated in logic block 612.

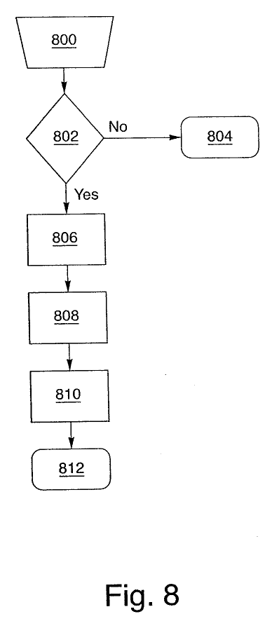

FIG. 8 illustrates the processing logic for the media copy control analog audio module in an exemplary embodiment. Processing starts in logic block 800 with the user beginning the import of audio from an analog source. In decision block 802, a test is made by the copy control program to determine if there is a copyright tone in the music. If no copyright tone is found, the copy control program returns to a watchdog mode as indicated in logic block 804. If the copy control program does find a copyright tone in the imported music, the copy control program watches the program that is importing the analog audio as indicated in logic block 806. The user then saves the analog audio as a file as indicated in logic block 808. Next, as indicated in logic block 810, the copy control program writes the copyright bit into the new file. The copy control program then returns to a watchdog mode as indicated in logic block 812.

Since the media copy control and media copy monitor programs use existing technology, there is no new hardware/software to be purchased in order to implement these programs. The two programs are simply inserted onto the new disk as they are released, and the programs will ensure that any file marked as copyrighted will not be allowed to be transferred over the Internet, or altered in a way that corrupts the copyright marker. This technology is also backward compatible, since many existing CDs already have been imprinted with an appropriate copyright marker. Additionally, the inclusion of these programs on the disk will not have any effect on the ability to play a conventional audio CD. The programs enable users to have the standard advantages of purchasing an audio CD, such as archiving on a home computer, making mix CD, and converting to MP3 format for use on MP3 players. The media copy control and media copy monitor programs can intercede in those situations where copyrighted material may be transferred over the Internet, or are being used in such a way which makes piracy a problem.

Both media copy control and media copy monitor are designed in such a way that they will function correctly on all standard platforms. They are also self-installing and virtually untouchable once they are in a computer. They cannot be accessed or altered without a lengthy trial and error effort by a skilled programmer, and the process of trying to access or alter these programs may incur damage to the computer itself.

The media copy control and media copy monitor programs can be implemented to function with different file formats. For audio files, for example, media copy control will recognize files by file types (e.g., MP3, WMA) and check each file type for a copyright marker.

### Preventing Unauthorized Access to Digital Data Stored on a System or Device

In another embodiment, the present invention provides a system and method for preventing tampering and unauthorized access to digital data stored on a computer, data store, network device, or consumer electronics device. The system can also prevent the unauthorized transmission of protected files across networks. The system can operate on a variety of platforms (e.g., iPod, Blackberry, cellphone, PDA, laptop, PCs, network device, consumer electronics device) and operating systems including Unix, Linux, and Windows (NT, XP, 2000).

Generally, the system can be configured to protect all digital data on a particular platform, or a subset of the digital data. The system can include a data store for containing digital data to be protected, and a listing of processes permitted to access the digital data. The data store can be a catalog or other data repository. A filter driver, such as a file system filter driver, can be included for intercepting a request issued from a process to access the digital data. The filter driver can act as a gate keeper by controlling access to the protected digital data. Filter drivers wrap the actual hardware driver, and have the ability to limit data moving in and out of any lower level driver.

A central processor controls the overall functionality of the system. The central processor can be in communication with the data store, and upon receiving a notification of the intercepted request from the filter driver, the central processor can decide to grant or deny the request by determining whether the process issuing the request is on the listing of processes permitted to access the digital data. The central processor may also be configured to grant access to any requesting process, which is not involved in network I/O or other disk I/O.

The system can also include a monitor process for monitoring one or more software components of the system including the central processor, filter driver, and data store, and for identifying and preventing any unauthorized processes from accessing and tampering with the software components of the system. The monitor process can ensure the installation of the filter driver, the continued running of the central processor, and the integrity of the data store. To prevent tampering, status fields can be associated with the central processor, filter driver, data store, and other software components of the system. If tampering is detected, each software component (e.g., central processor) can modify its respective status field to indicate the tampering. These status fields can be monitored by the monitor process, and if a change to a status field is identified, the system can respond in various ways including 1) sending a notification of tampering to a remote server, 2) generating an irrecoverable error condition requiring reboot of the system, 3) disabling the system permanently to prevent unauthorized access to the digital data, and 4) a combination of options 1) through 3).

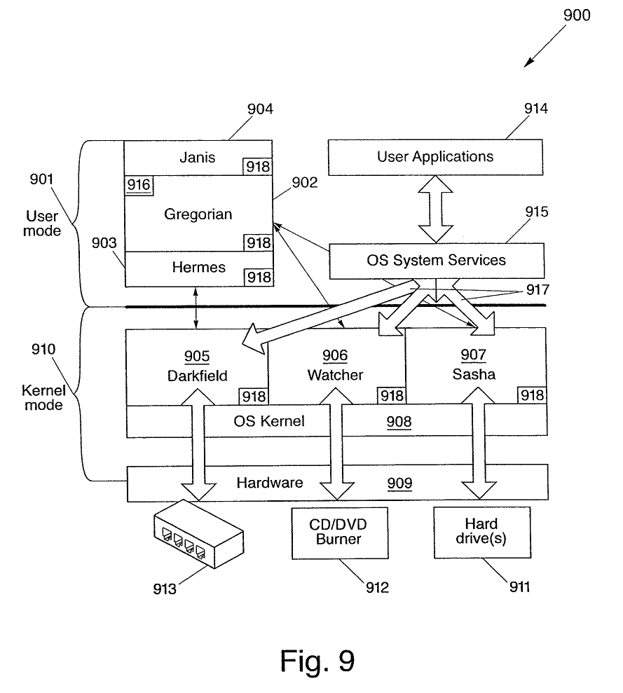

In an embodiment illustrated in FIG. 9, the system 900 can include multiple components that can interact with one another. Some of the components operate in user mode 901 portion of the system 900, while other components operate in kernel mode 910. The user mode 901 can be made up of subsystems, which can pass I/O requests to the appropriate kernel mode drivers via an I/O manager that resides in kernel mode. Kernel mode 910 has full access to the hardware 909 and system resources of the computer, and can execute code in a protected memory area. It controls access to scheduling, thread prioritization, memory management and the interaction with hardware 909.

A central processor 902 can serve as the main decision-making component of the system 900, and can coordinate, launch, and prioritize the activities of the other components. The central processor 902 can be configured to operate as a background process, such as, a Windows service or Unix daemon. The central processor 902 can include a data store 916, such as, a catalog or persistent data file that contains both, information about which files may be protected by the system 900, and a listing of authorized processes that can add and remove digital data from the data store 916. The data store 916 can be secured from tampering by encrypting the stored data, and by process level measures.

Another component of the system 900 can be a library 903 that can be dedicated to only serving the system 900. The library 903 can include various routines and modules that can be utilized by components of system 900, such as, the central processor 902, to accomplish various tasks. For instance, the central processor 902 can utilize routines in the library 903, to securely transfer protected content from the platform on which system 900 is operating to a remote computer or device. The library 903 can also include routines that can be utilized by the central processor 902 to perform public key authentications of servers and client platforms, as well as provide protection from “man-in-the-middle” (MITM) attacks. Various defenses against MITM attacks can include using authentication techniques that are based on public keys, stronger mutual authentication, secret keys, passwords, and other criteria, such as voice recognition and biometrics.

The library 903 may include other routines that can be utilized for compressing and decompressing content to minimize bandwidth use, for instance, in the transfer of large files and/or streamed files. Further, the library 903 can include routines to provide services, which may be similar to services offered by a particular operating system that system 900 is running on. Utilizing the routines in the library 903 to provide services can ensure that the system 900 is securely self-contained, and does not need to rely on the operating system to provide the services. The library 903 may also be utilized to create backup or duplicate copies of the protected content using the CD/DVD burner 912. In an embodiment, the library 903 can be configured to be transport layer agnostic, requiring only a network layer supporting TCP/IP.

As illustrated in FIG. 9, system 900 utilizes three sets of filter drivers 905, 906, 907 to monitor various process and operating system activity. This configuration is illustrated as merely a potential design option. Those skilled in the art will appreciate that the number of filter drivers can be variable, and that one or more filter drivers can be included in system 900 to monitor disk drives 911, CD/DVD burners 912, network service connections 913, etc.

In an embodiment, system 900 can include a set of kernel mode network filter drivers 905, such as, a Transport Driver Interface (TDI) filter driver and/or a Network Driver Interface Specification (NDIS) intermediate-mode filter driver, for passive monitoring of network services 913. In an embodiment, the network filter driver 905 can be controlled and monitored by the central processor 902. The network filter driver 905 can monitor which processes are using network services, and in what way the processes are using the network services. The network filter driver 905 can notify the central processor 902 of any attempted transfer of files or content to a network connection 913. The network filter driver 905 can be configured to monitor processes that attempt to access or manipulate content that is protected by system 900, or alternatively, any content located on the same platform as system 900.

In an embodiment, a set of kernel mode I/O filter drivers 906 can be included in system 900, and configured to monitor low-level I/O to a CD/DVD burner 912. The I/O filter drivers 906 can be Advanced SCSI Programming Interface (ASPI) layer filters. The I/O filter drivers 906 can identify and monitor processes that attempt to send files or content to the CD/DVD burner 912. The I/O filter driver 906 can immediately notify the central processor 902 of any such activity.

System 900 can also include a kernel mode file system filter driver 907, which can monitor file I/O activity and intercept requests 917 targeted at digital data (files and content) protected by system 900. By intercepting the request 917 before it reaches its intended target, the filter driver 907 can enforce and prevent unauthorized access of protected files. For example, the requests 917 can be generated by user applications 914 utilizing operating system calls 915. Depending on the platform that system 900 is operating on, the system calls 915 can be POSIX calls, Berkeley socket calls, I/O Request Packets (IRPs), fast I/O, etc. As the requests 917 for protected content enter the file system filter driver 907, the filter driver 907 can notify the central processor 902 of the request 917. In response, the central processor 902 can determine if the targeted content is protected, and if the requesting application 914 is authorized to access the particular content. The central processor 902 can accomplish this task by searching the data store 916, which contains identifying lists of files to be protected, and authorized processes that can access the protected content. Based on this information, the central processor 902 can decide to approve or disapprove the request 917. The central processor 902 can then notify the file system filter driver 907 of its decision. In response, the file system filter driver 907 can enforce the decision of the central processor 902, by passing the request 917 to the kernel 908, or by discarding the request 917.

In an embodiment, system 900 can include one or more identical monitor processes 918 that can identify and respond to tampering of system 900 in real-time. Monitor process 918 can be the first process to initiate on a new installation of system 900, and the last process to stop running when the system 900 is uninstalled from a particular platform. Each monitor process 918 can include multiple processes and kernel mode drivers, which can be interspersed throughout system 900. The monitor process 918 can track each component (902, 903, 904, 905, 906, 907) of the system 900, as well as each of its own processes and drivers to identify unauthorized tampering. Each monitor process can also track every other monitor process to ensure that none have been tampered with by an unauthorized process. Operating system processes and device driver configuration parameters can also be monitored by the monitor process 918 to identify unauthorized activity. The monitor process 918 can be configured for rebooting the system 900, and wiping the operating system to prevent tampering or unauthorized access to the digital data. The monitor process can ensure installation of the filter driver, continued operation of the central processor, and integrity of the data store.

Each monitor process 918 can share access to a shared memory area for interprocess communication, in order to determine if any one monitor process 918 is compromised, which would result in the need to generate another copy of the monitor process 918. Each monitor process 918 can be autonomous, and each will monitor the process list and other operating system configuration data to detect unauthorized processes.

In an embodiment, to detect tampering, status fields can be associated with each software component of the system including the central processor, filter driver, library, and data store. Each status field can pertain to a single software component, and can be modified by its respective software component to indicate whether any tampering to the software component has occurred. For further security, the status field of each software component can be encrypted with a proprietary scheme to ensure the status field is not modified by a rogue process. For example, status field can be encrypted using the software component's private key, and then the public key of the monitor process 918 in a two-way public key scenario. In this way, only a monitor process 918 may read what the status field is and can be reasonably certain that the software component originated the change status. Thus, it would be very difficult for a rogue process to configure itself to impersonate a component of the invention and send a false status thereby creating a denial of service attack.

The monitor process 918 can continuously monitor the status fields of each software component in system 900 to identify any changes. For example, if tampering is detected by the central processor 902, the central processor can then modify its respective status field to indicate the tampering. Thereafter, when the monitor process 918 detects the change to the status field pertaining to the central processor 902, the monitor process 918 can respond with various options including 1) sending a notification of tampering to a remote server, 2) disabling the system permanently to prevent unauthorized access to the digital data, 3) generating an irrecoverable error condition, such as a ring zero halt condition, requiring reboot of the platform housing system 900.

A ring or protection ring is a hierarchical protection domain, which can be utilized to protect data and functionality from faults and malicious behavior. Rings can be arranged in a hierarchy from most privileged to least privileged. On most operating systems, Ring 0 is the level with the most privileges and interacts most directly with the physical hardware, such as the CPU, memory, and device drivers.

As a further example, in normal operation the file system filter driver 917 may notice that another driver has been inserted on the platform housing system 900, and may consider this an attack. The filter driver 917 can change its current status field to indicate it is under attack and can then act to stop the flow of IRPs and Fast I/O passing through itself. The monitor process 918 can then detect the change in status, and can act immediately to address the situation by, for instance, shutting down the system to a non-operative state.

The monitor process 918 can also include an installer process that can be utilized to upgrade or reinstall damaged, compromised, or tampered with software components of the system 900. For example, if the monitor process 918 identifies that the central processor 902 may be damaged due to unauthorized hacking or tampering, the monitor process 918 can automatically launch a reinstall routine to upgrade the damaged central processor 902. In another embodiment, the monitor process 918 can connect to a remote server via a network connection (e.g., Internet), to download upgrades and regenerate system 900 or any of its software components. To overcome tampering, the monitor process 918 can also generate additional iterations of itself that operate simultaneously with other copies of the monitor process. Alternatively, the operation of each tampered with monitor process can be terminated, and replaced with a new iteration.

As an additional security feature, in an embodiment, the monitor process 918 can include a self-generating virus to prevent unauthorized copying of protected files and content. The monitor process 918 can pass the virus along with any unauthorized download of protected content.

In embodiments, system 900 can be designed for use in a variety of devices including an iPod, Blackberry, cellphone, PDA, computer, network device, or consumer electronics device. In addition, system 900 can be designed for use in a proprietary hardware device, which may be running a Linux-based operating system.

An advantage of the system 900 architecture is that it relies on the lowest level code to detect problems as they occur. The light-weight and transparent software components effect a device-wide response to any attack or condition. This is advantageous because it allows for the update of software components of the system 900 without requiring the reinstallation of the entire system.

System 900 can also include a user-interface 904, through which a user can troubleshoot and interact with the system 900.

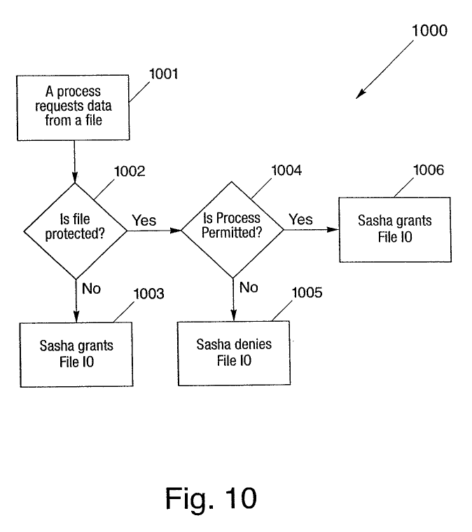

FIG. 10 depicts a flow chart illustrating the request processing procedure 1000 of system 900. Initially, in step 1001, a process requests data from a particular file. In step 1002, system 900 responds to the request by first determining if the requested file is one of the files protected by the system 900. If the file is not a protected file, then access to the file is granted to the requesting process in step 1003. If the file is a protected file, then in step 1004, the system 900 needs to determine if the requesting process is authorized to access the file. If the process is not authorized, then access is denied to the process in step 1005. If the process is authorized to access the file, then access is granted to the process in step 1006. Except when denying access of a particular file to a requesting process, system 900 can operate at a low level and in the background, so as to be unnoticeable to users and to applications running on the platform housing system 900.

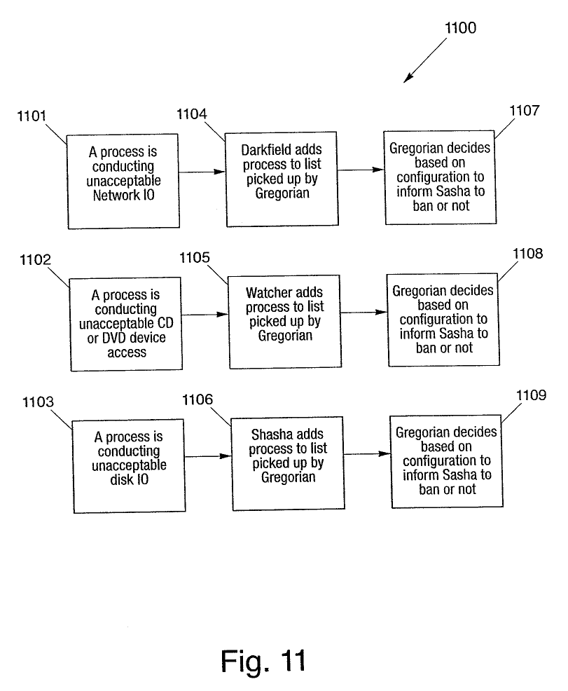

FIG. 11 illustrates the runtime operation 1100 of system 900. With reference also to FIG. 9, while system 900 is in operation, the network filter driver 905, I/O filter driver 906, and the file system filter driver 907 can be continuously monitoring and intercepting requests 917 from various processes 914. Specifically, in step 1101, a process 914 may be attempting to transfer a file to a network service connection 913. In step 1104, the network filter driver 905 can intercept the transfer request 917 from the process 914, and can notify the central processor 902 of the potential violation. In step 1107, the central processor 902 can then search the data store 916 to determine if the particular file is protected by system 900, and if the requesting process 914 is authorized to access the file. Based on this determination, the central processor 902 can decide to approve or disapprove the request 917. The central processor 902 can then notify the file system filter driver 907 of its decision. In response, the file system filter driver 907 can enforce the decision of the central processor 902, by passing the request 917 through, or by discarding the request 917.

Similarly, in step 1102, another process 914 may be attempting to make unauthorized copies of protected files via CD/DVD burner 912. In this instance, shown in step 1105, the I/O filter driver 906 can intercept the request 917, and can notify the central processor 902 of the potential violation. In step 1108, the central processor 902 can then search the data store 916 as discussed above to determine if the request 917 should be approved or disapproved. The central processor 902 can then notify the file system filter driver 907, which can then enforce the decision of the central processor 902 as discussed above.

In step 1103, a third process 914 may be attempting to read or write a file to a hard drive 911. In step 1106, the file system filter driver 907 can intercept the request 917, and can notify the central processor 902 of the potential violation. In step 1109, just as in steps 1107 and 1108 discussed above, the central processor 902 can determine whether or not the request 917 should be allowed, and can inform the file system filter driver 907 of its decision. The file system filter driver 907 can then pass or discard the request 917 in accordance with the decision of the central processor 902 as discussed above.

In an embodiment, the decision criteria by which the central processor 902 can decide to permit or deny I/O requests 917 can have a flexible configuration, and can be based on a variety of criteria including network, device, and file system activity. Alternatively, the decision criteria can have a rigid configuration, such as, a set list of authenticated processes that support an exchange of credentials. This flexibility allows the system 900 to have a broad range of uses, from a security system for restricting use of digital purchases on a PC, to a dedicated device serving protected content in only a very select manner.

Additional kernel and user mode monitors can be added to system 900, and can be utilized to supply information to the central processor 902. The system 900 can utilize the supplemental information to monitor the behavior of processes 914 at a low-level, to enable user-mode system decision making for low-level file system policing of protected content.

In an embodiment, system 900 can operate in several modes depending on how it is installed. As a result, digital data can be brought under the protection of system 900 in several ways. In an embodiment, the digital data itself can be determinative. For example, if a process 914 tries to read an MP3 audio file that has its copyright bit set to true, then the system 900 will protect the file. This implementation may be referred to as “global” mode. An advantage of global mode is that it requires only knowledge of the file formats that it needs to protect. Since, only processes 914 that are approved can modify the file, the copyright bit cannot be altered without the permission of the central processor 902. In normal operation, the system 900 does not change the format of the protected content in any way.

In another embodiment, the system 900 can be installed to protect a vendor's content on a PC. This configuration may be referred to as “guest” mode. In this instance, the central processor 902 can utilize data store 916, which can include a catalog or a persistent file on disk, to store a list of content to protect. Similarly, the central processor 902 can also add approved and disapproved processes 914 to a listing in the data store 916. The data store 916 or persistent file itself can be protected by the system 900, and in an embodiment, only the central processor 902, file system filter driver 907, and monitor process 918 can access it.

In an embodiment, the system 900 can be installed in a device, such as a dedicated consumer electronics product, rather than an end-user software component for a traditional PC environment. This configuration may be referred to as “prime” mode. In prime mode the guest mode cache may not be needed. As a result, the data store 916 can be configured as a full file system, and the file system filter driver 907 can be replaced with the file system driver. Therefore, when the central processor 902 delivers a protected file to the device via the library 916, the protected file can be placed in a protected region by the file system driver. The file system driver can then track all the files under the protection of system 900, and can provide this information to the central processor 902 at anytime or on demand. By controlling the function of the file system, the system 900 can handle large numbers of protected files, and/or very large files being streamed asynchronously in and out of the file system driver. Such a configuration can simplify the design of the system 900, and can increase security. For example, rebooting an end-user computer to stop a tampering process might be unacceptable in a PC environment, but may be completely acceptable for a consumer electronics device. In addition, the entire file system can be encrypted to further increase security for the protected content.

The present invention can be utilized in a variety of business models and commercial product applications, for instance, as an audio and video content management system. In one embodiment, the present invention can be implemented as a stand-alone proprietary hardware device, which can allow consumers to download movies, music and TV shows directly to the hardware device for later viewing on a TV or Home theatre. The content itself may be purchased or rented, and may be shared with other owners of the proprietary hardware device. In an embodiment, the hardware device can include a proprietary operating system that may be Linux based.

In another embodiment, the present invention can be implemented as an application on a PC, to allow for the purchase and download of media content. Consumers can download the application in order to purchase content. The application can perform all content management activities, and can appear as seamless to the user. The downloaded content can then be utilized on iPod/iTunes and Zune/Microsoft media players.

In another embodiment, the present invention can be implemented as an on-demand cable system, which can allow consumers to pay only for the content they watch. Consumers may choose to buy a number of channels, or they may choose to buy a particular set of shows. The content can be protected from unauthorized transmission as discussed above. In an embodiment, the content can be delivered via the Internet to a proprietary hardware device. Alternatively, the content can be viewed on portable devices, such as, iPods, laptops, PDAs, Blackberry, etc.

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

We claim:

1. A system for preventing unauthorized access to digital data stored on a device comprising:
a data store for containing digital data to be protected and a listing of processes permitted to access the digital data;
a filter driver for intercepting a request issued from a process to access the digital data;
a central processor, in communication with the data store, upon receipt of a notification of the intercepted request from the filter driver, deciding to grant or deny the request by determining whether the process issuing the request is on the listing of processes permitted to access the digital data; and
a monitor process for monitoring one or more software components of the system including the central processor, filter driver, and data store, and for identifying and preventing any unauthorized processes from accessing and tampering with the software components of the system.

2. The system of claim 1, wherein the filter driver is designed to permit the requesting process to access the digital data or deny access to the digital data, based on instructions received from the central processor.

3. The system of claim 1, further comprising a status field associated with each software component of the system, the status field modifiable by each respective software component to indicate whether unauthorized access or tampering to the software component has occurred.

4. The system of claim 3, wherein each monitor process is capable of monitoring each software component of the system to determine the status of each of the software components.

5. The system of claim 1, wherein the monitor process includes an installer software component for reinstalling damaged or compromised components of the system.

6. The system of claim 1, wherein each monitor process is identical to every other monitor process, and each monitor process operates autonomously in a shared memory area for interprocess communication.

7. The system of claim 1, wherein each monitor process is capable of spawning additional iterations of itself that operate simultaneously on the system.

8. The system of claim 1, wherein each monitor process is capable of generating a new iteration of itself when the monitor process is damaged or tampered with by an unauthorized process.

9. The system of claim 8, wherein the damaged monitor process is terminated after the new iteration is generated.

10. The system of claim 1, wherein the monitor process is capable of rebooting the system.

11. The system of claim 1, wherein the monitor process is capable of wiping the operating system to prevent tampering or unauthorized access to the digital data.

12. The system of claim 1, wherein the monitor process is capable of ensuring installation of the filter driver, continued operation of the central processor, and integrity of the data store.

13. The system of claim 1, designed for use in a number of devices including an iPod, Blackberry, cellphone, PDA, computer, network device, or consumer electronics device.

14. The system of claim 1, designed for use in a proprietary hardware device running a Linux-based operating system.

15. A method of preventing unauthorized access to digital data stored on a device, the method comprising:
providing a data store of protected digital data;
receiving a request for digital data from a process;
determining whether the request is for protected or not protected digital data; and
if the request is for protected data, implementing one of 1) granting the request if the process is authorized to access the digital data, 2) denying the request if the process is not authorized to access the digital data.

16. A method of preventing tampering and unauthorized access to digital data stored on a system, the method comprising:
providing a system having 1) a data store for containing digital data to be protected and a listing of processes permitted to access the digital data, 2) a filter driver for intercepting a request issued from a process to access the digital data, 3) a central processor in communication with the data store, upon receiving a notification of the intercepted request from the filter driver, deciding to grant or deny the request by determining whether the process issuing the request is on the listing of processes permitted to access the digital data, and 4) at least one monitor process for monitoring one or more software components of the system including the central processor, filter driver, and data store, and for identifying and preventing any unauthorized processes from accessing and tampering with the software components of the system;
monitoring status fields associated with the central processor, filter driver, data store, and other software components of the system to identify unauthorized changes in the status field; and
responding to changes in the status field by performing one of 1) sending notification of tampering to a remote server, 2) generating an irrecoverable error condition requiring reboot of the system, 3) disabling the system permanently to prevent unauthorized access to the digital data, and 4) a combination of 1) through 3).

17. The method of claim 16, further comprising monitoring each software component of the system to identify changes in the status of the component.

18. The method of claim 16, further comprising monitoring operating system processes and device driver configuration parameters to identify unauthorized activity.

19. The method of claim 16, further comprising launching a reinstall routine to upgrade damaged or compromised components of the system.

20. The method of claim 16, further comprising connecting to a remote server via a network connection to regenerate or download upgrades of compromised components of the system.

21. The method of claim 16, further comprising tracking each monitor process to ensure each monitor process is not tampered with by an unauthorized process.

22. The method of claim 21, further comprising generating additional iterations of the monitor process when tampering is identified, each additional iteration operating simultaneously with other copies of the monitor process.

23. The method of claim 21, further comprising generating additional iterations of the monitor process when tampering is identified, and terminating the operation of each tampered with monitor process.

24. The method of claim 16, wherein the step of responding further includes passing a software virus along with any unauthorized download of protected digital data.

25. The method of claim 16, further comprising encrypting the status of each software component with a proprietary scheme to ensure the status is not modified by a rogue process.
